(19) United States
(12) Patent Application Publication
(10) Pub. No.: US 2007/0118240 A1
(43) Pub. Date: May 24, 2007

(54) Accessory multi-media player

(76) Inventors: Kuo Hsiung Cho, Zhubei (TW); Chin-I Liu, Zhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,123

(22) Filed: Nov. 16, 2005

(51) Int. Cl. G06F 17/00

(52) U.S. Cl. 700/94

(57) ABSTRACT

An accessory for attachment to a portable electronic device is disclosed. The accessory has a display unit, a processor, a communication interface and a housing.

### BACKGROUND OF THE INVENTION

1. Field of the Invention

The present invention relates to a multi-media player, and more especially, to an accessory multi-media player.

2. Background of the Related Art

There are many portable devices with big memory storage, but they may not have the media (both video and audio, or only have audio but no video) playing function. Most of them with big memory storage, such as HDD, have standard interfaces such as IDE (Integrated Drive Electronics), USB or IEEE1934 (fire wire). The memories such as HDD and flash memory are all very expensive. Moreover, the devices using these memory storages are hence also very expensive. The best example is the ipod product (trademark of Apple Corporation) that has a very large HDD memory storage but only MP3 playing function.

It is desirable to use portable devices' memory storage to store, for example video contents, and design an accessory capable of reading and playing the content through its interface, for example dock connector for iPod. The cost of adding only a display module is much less than a stand along video playing device with large memory storage. That is consumers could pay less money to add a video playing function to enjoy video function, rather than purchase a new unit with video function by paying more money if they already have iPod or ipod-like products. The similar idea could be applicable to all devices equipped with large memory storage. Designing an accessory with video or game function and making use the original memory storage is making sense of saving the cost of the expensive storage.

### SUMMARY OF THE INVENTION

In order to solve the problems mentioned above, the present invention provides an accessory which attaches to the portable multi-media player and adds video (media, game) playing function to the player.

The accessory multi-media player is that a standard interface is disposed in the housing to be coupled with the multi-media player directly or indirectly through cables, and the accessory multi-media player has the host function to access the multi-media files stored in the multi-media player through the interface and is capable of processing the media files to be displayed through its display unit. The accessory multi-media player is portable and can be used conveniently.

The present invention thus provides an entertainment accessory for people and allows them to watch video or the like without the need of buying a new device with the same functions but equipped with expensive memory storage for cost saving.

Accordingly, one embodiment of the present invention provides an accessory multi-media player comprising a main frame having a housing to which a multi-media player equipped with a memory storage attaches, a communication interface making a connection and receiving the data from the multi-media player, a processor coupled to the communication interface for receiving and processing the data, then outputting the multi-media data stream, a display unit coupled to the processor for receiving the multi-media data stream and displaying an image or moving pictures, and at least a speaker coupled to the processor for receiving the multi-media data stream and delivering sound. BRIEF DESCRIPTION OF THE DRAWINGS

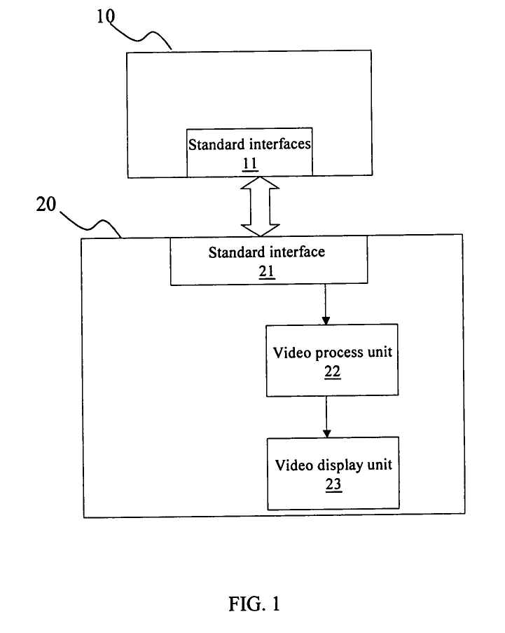

FIG. 1 is a diagram of accessory multi-media connecting with a device in accordance with an embodiment of the present invention.

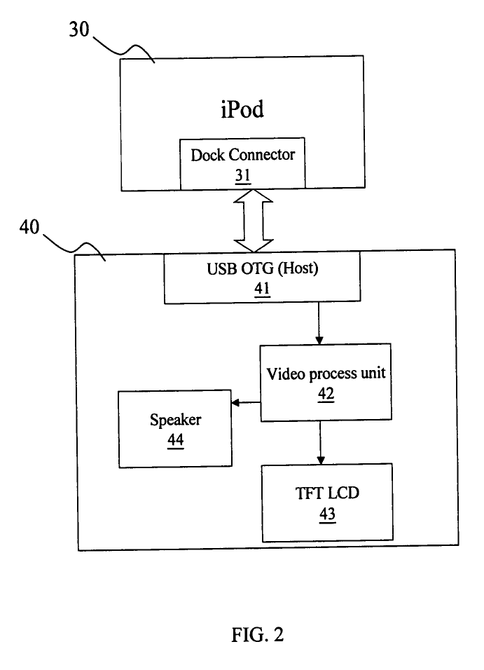

FIG. 2 is another diagram of accessory multi-media connecting with a multi-media player in accordance with an embodiment of the present invention.

### DETAILED DESCRIPTION OF THE INVENTION

FIG. 1 is a diagram of accessory multi-media connecting with a device in accordance with an embodiment of the present invention. A device 10 equipped with memory storage (HDD, Flash memory or non-volatile memories) has a standard interface 11, for example USB, IDE and IEEE1934, etc. An accessory multi-media player 20 according to an embodiment of the present invention includes a main frame having a housing to which a multi-media player 10 attaches.

A communication interface uses standard interface 21 to connect the standard interface 11 and receives the multimedia content from the memory storage equipped in multi-media player 10.

A processor 22 and the like electrically couples to standard interface 21 for receiving data, then processes the data and outputs the multi-media data stream to a display unit 23, which receives multi-media data stream and displays images or moving pictures.

Furthermore, the device 10 is a multi-media player, such as portable music player, MP3 player, flash memory disk or an external HDD.

FIG. 2 is another diagram of accessory multi-media connecting with a multi-media player in accordance with an embodiment of the present invention. A MP3 player iPod 30 with 20, 40, or 60 GB HDD memory has a dock connector 31 which is USB or fire wire compatible interface. The accessory multi-media player 40 may house the iPod 30 and use USB interface 41 to connect the dock connector 31. The USB interface 41 has the host function, for example USB OTG (On-the-Go), thus the video process unit 42 may receive multi-media data stored in the HDD memory through USB interface 41. After multi-media data being processed, the motion pictures or images are displayed on the flat panel display 43 and the sound is delivered to the air through the speaker 44 (or external headphone). The headphone interface (not shown) is disposed in the housing that permits the music files to be played through external headphones connected.

Furthermore the flat panel display 43 may be a color super-twist nematic (CSTN) LCD, organic LED, or a thin film transistor (TFT) LCD. The processor 42 may be a digital signal processor (DSP) or a micro controller unit (MCU) with video CODEC function.

Accordingly, one of features of the present invention is to provide an accessory multi-media player reading the content through its dock connector and playing the content. The cost of adding only a display module is much less than a stand along video playing device with big storage. That is consumers could pay less money to add a video playing function to enjoy video function, rather than purchase a new unit with video function by paying big money if they already have ipod. The similar idea could be applicable to all big storage devices. Designing an accessory with video or game function and make use the original storage is making sense of saving the cost of expensive storage.

Accordingly, one embodiment of the present invention provides an accessory with the host function to these standard interfaces (the original storage device to be the slave) and is capable of adding functions to those devices. Furthermore, the present invention is to make use the usually very expensive storage resource and provides an accessory with a function (such as video playing or game function) capable of using the storage and saving the storage cost.

Although the present invention has been explained in relation to its preferred embodiment, it is to be understood that other modifications and variation can be made without departing the spirit and scope of the invention as hereafter claimed.

What is claimed is:

1. An accessory multi-media player comprising:
a main frame having a housing to which a device equipped with a memory storage attaches;
a communication interface for making a connection and receiving data from the multi-media player;
a processor electrically coupled to said communication interface for receiving said data, then outputting a multi-media data stream;
a display unit electrically coupled to said processor for receiving said multi-media data stream and displaying images or moving pictures; and
at least a speaker electrically coupled to said processor for receiving said multi-media data stream and delivering sound.

2. The accessory multi-media player according to claim 1, wherein said device is a multi-media player.

3. The accessory multi-media player according to claim 2, wherein said multi-media player is a portable music player or MP3 player.

4. The accessory multi-media player according to claim 2, wherein said device is a flash memory disk or an external HDD.

5. The accessory multi-media player according to claim 1, wherein said multi-media player has a communication interface.

6. The accessory multi-media player according to claim 5, wherein said communication interface is Universal Serial Bus (USB), Integrated Drive Electronics (IDE), or IEEE1934 standard interface.

7. The accessory multi-media player according to claim 6, wherein said communication interface has on-the-go (OTG) host function of USB.

8. The accessory multi-media player according to claim 1, wherein said processor is a digital signal processor (DSP) or a micro control unit (MUC) with video CODEC function.

9. The accessory multi-media player according to claim 1, wherein said display unit is flat panel display (FPD).

10. The accessory multi-media player according to claim 9, wherein said flat panel display is a color super-twist nematic (CSTN) LCD a thin film transistor (TFT) LCD, or OLED.

11. The accessory multi-media player according to claim 1, further comprising a headphone interface disposed in the housing that permits the music files to be played through external headphones connected thereto.
